(19) United States
(12) Patent Application Publication
(10) Pub. No.: US 2004/0105618 A1
(43) Pub. Date: Jun. 3, 2004

(54) Apparatus and method for making temperature compensated optical fiber diffraction gratings

(76) Inventors: Nicholas A. Lee, Woodbury, MN (US); Gordon Wiegand, Austin, TX (US)

Correspondence Address: 3M INNOVATIVE PROPERTIES COMPANY, PO BOX 33427, ST. PAUL, MN, 55133-3427, US

(21) Appl. No.: 09/751,883

(22) Filed: Dec. 29, 2000

(51) Int. Cl. G02B 6/34

(52) U.S. Cl. 385/37

(57) ABSTRACT

An apparatus for temperature compensation of a region of an optical fiber includes a first member having a positive coefficient of thermal expansion, wherein at least a portion of the first member lies in a first plane, and a second member on the first member, wherein the second member has a coefficient of thermal expansion lower than the coefficient of thermal expansion of the first member. A mount for the optical fiber is substantially normal to the first plane and extends a predetermined distance from the first plane.

### TECHNICAL FIELD

This invention relates to optical fiber diffraction gratings, and more particularly to an apparatus and method for making a temperature compensated optical fiber diffraction grating.

### BACKGROUND

An optical filter may be placed in a selected region of an optical fiber device to reflect a particular wavelength of incident light. One such filtering device is the Bragg grating, a diffraction grating impressed into the optical fiber core. To create a Bragg grating, a permanent refractive index change is induced in a predetermined region of the optical fiber core, which creates a phase grating effective to reflect light in the core at selected wavelengths. Bragg gratings are important components in communications systems that multiplex and transmit optical signals having different wavelengths through one optical fiber.

A change in ambient temperature causes the optical fiber to expand and contract, which alters the period of the Bragg grating and the refractive index of the fiber. These changes alter the reflection wavelength of the Bragg grating and limit the usefulness of the Bragg grating as a filter.

In an effort to significantly reduce the influence of temperature variations on the wavelength selectivity of an optical fiber Bragg grating, temperature compensated devices have been proposed in which shifts in reflection wavelength caused by temperature changes in the grating region of the optical fiber core are counteracted by applying an axial strain to the grating region during the manufacturing process.

For example, referring to FIG. 1, an apparatus 10 is shown that may be used for temperature compensation of a Bragg grating 12 in a region of an optical fiber 14. The compensation apparatus 10 includes aluminum brackets 16, 18 with a large coefficient of thermal expansion, mounted at opposed ends of a rod 20 made of a material with a small coefficient of thermal expansion, such as, for example, glass or a 36 wt% nickel/ 64 wt% iron alloy known in the art as INVAR. The optical fiber 14 is fixed to the brackets 16, 18 under a predetermined axial tension using an adhesive and/or mounting latches 22, 24. The Bragg grating 12 is positioned between the mounting latches 22, 24 and placed under axial tension. As the ambient temperature rises, the grating 12 fixed to the mounting latches 22, 24 expands, while the brackets 16, 18 expand and decrease the distance between the mounting latches 22, 24. The compressive axial strain applied to the optical fiber 14 by the brackets 16, 18 reduces the tension in the grating and counteracts the temperature induced expansion in the Bragg grating 12, which prevents changes in the reflection wavelength of the Bragg grating 12 with fluctuations in ambient temperature.

An alternative conventional temperature compensation device 30 is shown in FIG. 2A. The device 30 includes a first bar 32 of a first material with a small coefficient of thermal expansion and having a length L. The first bar 32 has a thickness d_{low}. The device 30 also includes a second bar 34 of a second material with a high coefficient of thermal expansion and having a length L and a thickness d_{high}. The total distance of the first bar 32 and the second bar 34 from a plane 31 is D. An optical fiber 36 with a Bragg grating region 38 is bonded to a top surface 33 of the first bar 32 with a solder or an adhesive. Referring to FIG. 2B, as the ambient temperature increases, the differences in the coefficients of thermal expansion in the bars 32, 34 cause the device 30 to bend upward at its ends. This bending applies a compressive axial strain and reduces the tension to the Bragg grating region 38, which counteracts the temperature-induced expansion of the grating. Referring to FIG. 2C, as the ambient temperature decreases, the differences in the coefficients of thermal expansion in the bars 32, 34 cause the device 30 to bend downward at its ends, which applies a tensile axial strain to the Bragg grating region 38 to counteract the temperature-induced contraction of the grating.

### SUMMARY

While effective, the compensation apparatus of FIGS. 1-2 make consistent and accurate temperature compensation of the Bragg grating difficult to achieve during the manufacturing process. To ensure accurate tuning with the device of FIG. 2, materials must be carefully selected and formulated to obtain, if possible, the proper negative temperature coefficient of expansion to counteract the change in refractive index of the Bragg grating region of the optical fiber. Very few, if any, material combinations are available to provide the required negative coefficient of thermal of about −9×10⁻⁶ for adequate temperature compensation for an optical fiber Bragg grating. The optical fiber must be precisely aligned with the apparatus of FIG. 1, and then precisely adhered or clamped to the apparatus. Errors in the alignment and/or attachment procedure damage the Bragg grating, and the entire optical fiber device must be discarded. As one of the final steps in the Bragg grating manufacturing process, tuning errors are costly and have a significant impact on manufacturing yield.

In a first aspect, the invention is an apparatus for temperature compensation of a region of an optical fiber. The apparatus includes a first member having a positive coefficient of thermal expansion, wherein at least a portion of the first member lies in a first plane. A second member on the first member has a coefficient of thermal expansion lower than the coefficient of thermal expansion of the first member. A mount for the optical fiber is substantially normal to the first plane and extends a predetermined distance from the first plane.

In a second aspect, the invention is a method for temperature compensating a region of an optical fiber with a diffraction grating. The method includes providing a temperature compensation apparatus a first member having a positive coefficient of thermal expansion, wherein at least a portion of the first member lies in a first plane, a second member on the first member, wherein the second member has a coefficient of thermal expansion lower than the coefficient of thermal expansion of the first member; and a mount for the optical fiber. The mount includes a first tower and a second tower. The towers are substantially normal to the first plane and extend a predetermined distance from the first plane. The optical fiber is attached to the first and second towers such that the optical fiber region lies between them.

In a third aspect, the invention is a temperature compensating package for a fiber optic Bragg grating, including an enclosure with a first end and a second end. An optical fiber mount is on a first end of the enclosure, and a temperature compensating washer is on the second end of the enclosure. The washer includes a disk with an aperture, wherein the disk has a first layer adjacent the second end of the enclosure and a second layer on the first layer, wherein the first layer has a positive coefficient of thermal expansion and the second layer with a coefficient of thermal expansion lower than the coefficient of thermal expansion of the first layer.

In a fourth aspect, the invention is a temperature compensating optical device, including a first member having a positive coefficient of thermal expansion, wherein at least a portion of the first member lies in a first plane, a second member on the first member, wherein the second member has a coefficient of thermal expansion lower than the coefficient of thermal expansion of the first member, and a mount for the optical fiber. The mount includes a first tower and a second tower, wherein the first and second towers are substantially normal to the first plane and extend a predetermined distance from the first plane. An optical fiber is attached to the first and second towers, and a region between the first and second towers includes a diffraction grating.

In a fifth aspect, the invention is a temperature compensating optical device, including an enclosure with a first end and a second end, an optical fiber mount on a first end of the enclosure, and a temperature compensating washer on the second end of the disclosure, wherein the washer includes a disk with an aperture. The disk includes a first layer adjacent to the second end of the enclosure and a second layer on the first layer, wherein the first layer has a positive coefficient of thermal expansion and the second layer with a coefficient of thermal expansion lower than the coefficient of thermal expansion of the first layer. An optical fiber attached to the fiber mount and the washer, wherein a region of the optical fiber is within the enclosure, and wherein the region includes a diffraction grating.

The details of one or more embodiments of the invention are set forth in the accompanying drawings and the description below. Other feature invention will be apparent from the description and drawings, and from the claims.

### DESCRIPTION OF DRAWINGS

FIG. 1 is a cross sectional view of an optical fiber temperature compensating apparatus.

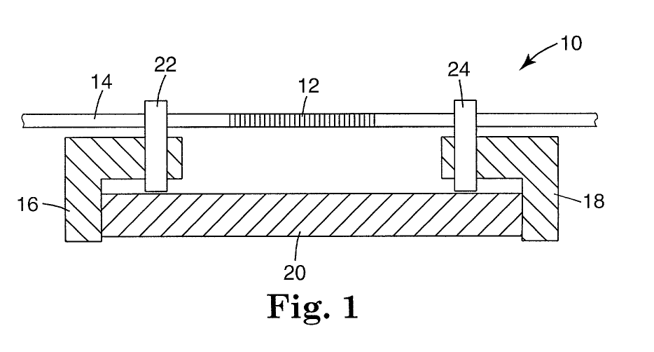

FIGS. 2A-2C are cross sectional views of a two component optical fiber temperature compensating apparatus.

FIGS. 3-4 are cross sectional views of an optical fiber temperature compensating apparatus of the invention with an elevated fiber mount.

FIG. 5 is a side view of an optical fiber temperature compensating apparatus of the invention having a tower with a height adjusting notch.

FIGS. 6-7 are cross sectional views of an optical fiber temperature compensating apparatus of the invention.

FIGS. 8-9 are cross sectional views of temperature-compensating optical fiber package.

Like reference symbols in the various drawings indicate like elements.

### DETAILED DESCRIPTION

The invention is an apparatus and method for temperature compensation of a region of an optical fiber, which limit any temperature-induced change in the optical properties of the section or in an optical structure within the region. In a preferred embodiment, the invention provides an apparatus for limiting the change in reflection wavelength of an optical fiber diffraction grating with a change in temperature. The structure of the apparatus forces an axial elongation of the section of the fiber containing the diffraction grating with decreasing temperature, or an axial shortening of the fiber with increasing temperature.

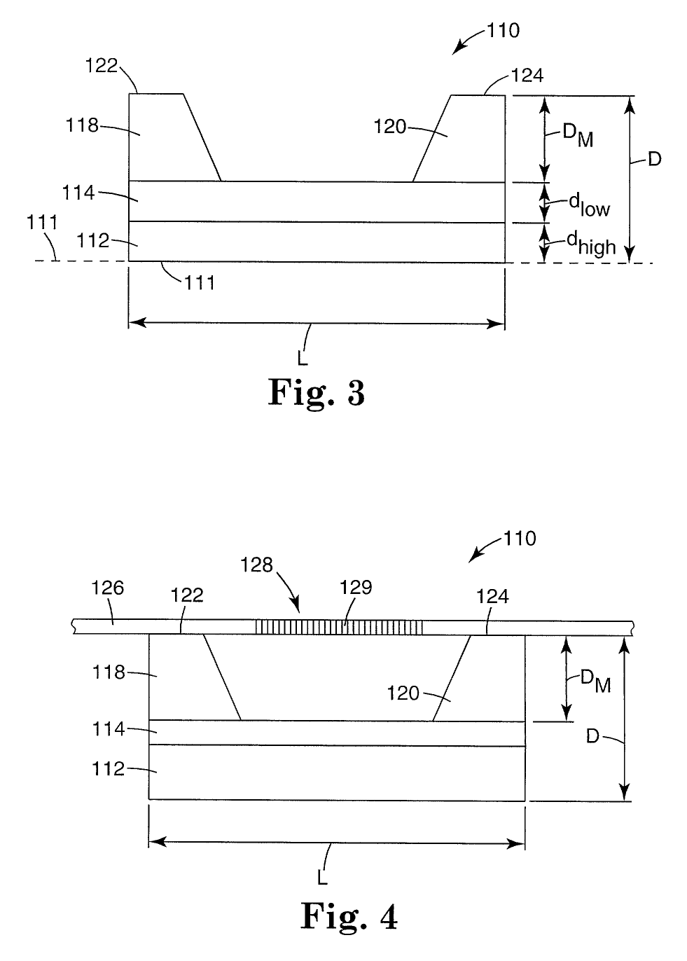

Referring to FIG. 3, a temperature compensation apparatus 110 of the invention is shown at a nominal temperature where no bending of the structure occurs. The apparatus 110 includes a first member 112 and a second member 114. The first member 112 may have any desired shape, and is preferably substantially planar at the nominal temperature. The first member 112 is made of a material with a positive coefficient of thermal expansion, preferably a metal such as, for example, stainless steel or copper. The first member 112 has a thickness measured herein as its distance, d_{high} above a plane 111. The second member 114 is bonded to the first member 112 by any suitable method and may also have any desired shape, preferably substantially planar, to substantially conform to the shape of the first member 112. The second member 114 is made of a material with a coefficient of thermal expansion less than the coefficient of thermal expansion of the first member 112. Examples of suitable materials for the second member 114 include glass, quartz, and low expansion metal alloys such as INVAR. The second member has a thickness referred to in FIG. 3 as d_{low}.

ASTM standards have been established for bimetallic strips for use in the thermostat industry and a wide variety of compositions are described in ASTM B 388-94. Any of these bimetallic strip configurations may be used in the invention. A preferred bimetallic composition is ASTM-TM2, in which the first member has a composition of 10 wt % Ni, 72 wt % Mn, and 18 wt % Cu and the second member has a composition of 36 wt % Ni and 64 wt % Fe.

Although only two members are shown and described in this embodiment, either the first member 112 or the second member 114, or both, can include a vertical stack of multiple layers of materials having the same or different coefficients of thermal expansion, bonded together.

An elevated fiber mount 116 is attached to the stacked members 112, 114. The fiber mount 116 may have any desired shape, and in this embodiment the mount 116 includes a first mounting tower 118 and a second mounting tower 120. The mounting towers 118, 120 may be made from a wide variety of materials depending on the intended application, the dimensions and shape of the towers, and the materials selected for the first and second members 112, 114. Materials selected for the mounting towers 118, 120 preferably have a coefficient of thermal expansion less than that of the first member 112, and are more preferably made of the same material as the second member 114. Each mounting tower 118, 120 includes a substantially planar mounting surface 122, 124, respectively, for attachment of an optical fiber. The mounting surfaces 122, 124 may extend any desired distance D_{M} away from the surface of the second member 114 and a total distance D, measured normal to the plane 111. Preferably, the mounting surfaces 122, 124 are the same distance D away from the plane 111.

The mount 116 moves the attached optical fiber an additional distance D_{M} away from the plane 111 and amplifies the deflection of the stacked members 112, 114. This amplified deflection allows more options for materials from the stacked members 112, 114, including less expensive materials.

Referring to FIG. 4, an optical fiber 126 is mounted to the respective mounting surfaces 122, 124 by any method known in the art. For example, the fiber 126 may be attached to the mounting surfaces 122, 124 using a heat cured adhesive such as an epoxy resin. Alternatively, the mounting surfaces 122, 124 and/or the optical fiber may be metallized, and a solder may be used to form a removable fiber to tower bond. The fiber mounting surfaces 122, 124 may also include notches, clamps, sleeves or other attachment devices (not shown in FIG. 4) to position and/or releaseably attach the optical fiber 126. The fiber 126 includes a region 128 with a diffraction grating 129 referred to in the art as a Bragg grating or fiber Bragg grating (FBG). Preferably, the region 128 is positioned between the towers 118, 120 so that deflection of the towers in a direction normal to the plane 111 applies an axial strain to the region 128.

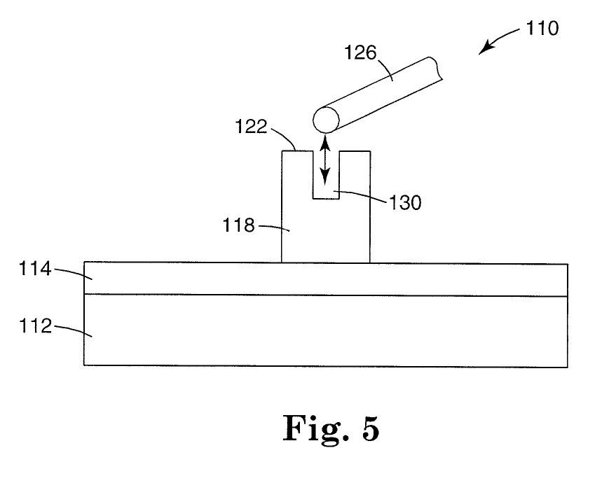

To apply this axial strain accurately, the distance D_{M} should be carefully controlled. Changes in the distance D_{M} will result in an increase or decrease of the strain applied to the region 128, so during the process of tuning the diffraction grating it is desirable to alter the distance D_{M} in small increments in a direction normal to the plane 111. For example, referring to FIG. 5, the distance D_{M} may be varied along a machined notch 130 in the tower 118. To facilitate adjustability, the notch 130 may include gradations and/or a threaded coupler (not shown in FIG. 5).

In a preferred method for manufacturing an optical fiber diffraction grating, after the grating is written into the region 128 (FIG. 4), the optical fiber 126 is bonded to each of the towers 118, 120 by an appropriate method such that the diffraction grating 129 is positioned between the towers. In this method, the optical fiber is always under tension during normal operation when typical temperatures are in the range of about −40° C. to about +80° C. The amount of strain on the fiber is then well within its design limits. However, if the optical fiber 128 is bonded at a temperature lower than the highest operating temperature, it is preferable to place the fiber under sufficient tension during bonding to ensure that it will always be under tension over its operating temperature range. The apparatus 110 curves as a result of the differential between the coefficients of thermal expansion of the first and second members 112, 114. This curvature is amplified by the towers 118, 120 and transferred to the grating 129 as an axial strain such that the grating 129 experiences a desired coefficient of thermal expansion in the range of about −9×10⁻⁶.

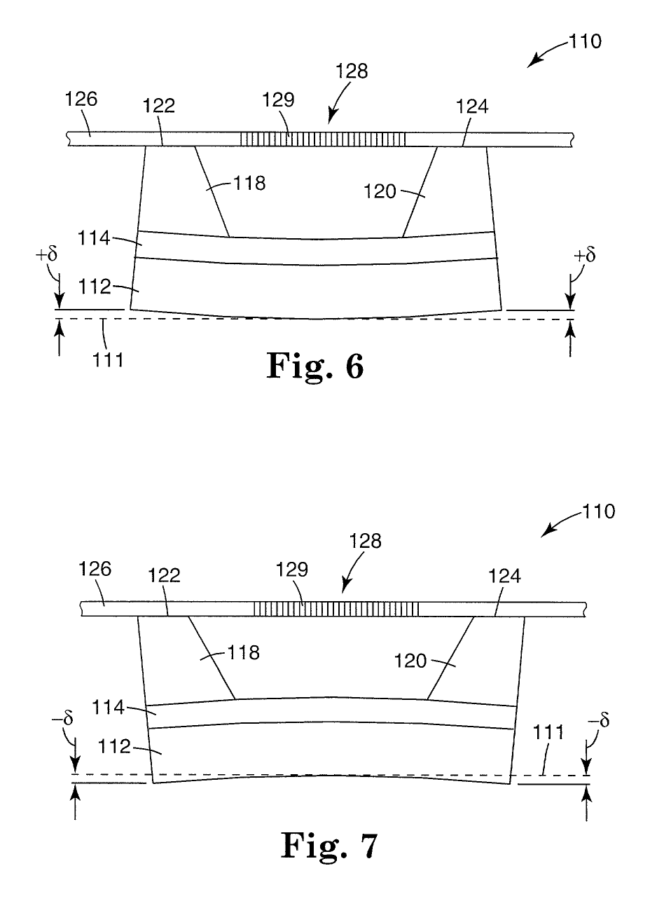

Referring to FIG. 6, as the temperature increases, the ends of the first and second members 112, 114 move a distance +δ away from the plane 111. At the distance D_{M} away from the second layer 114, the optical fiber region 128 experiences an axial strain sufficient to compensate for temperature variations. Referring to FIG. 7, as the temperature decreases, the ends of the first and second members 112, 114 move a distance −δ away from the plane 111. At the distance D_{M} away from the second layer 114, the optical fiber region 128 experiences an axial strain sufficient to compensate for temperature variations.

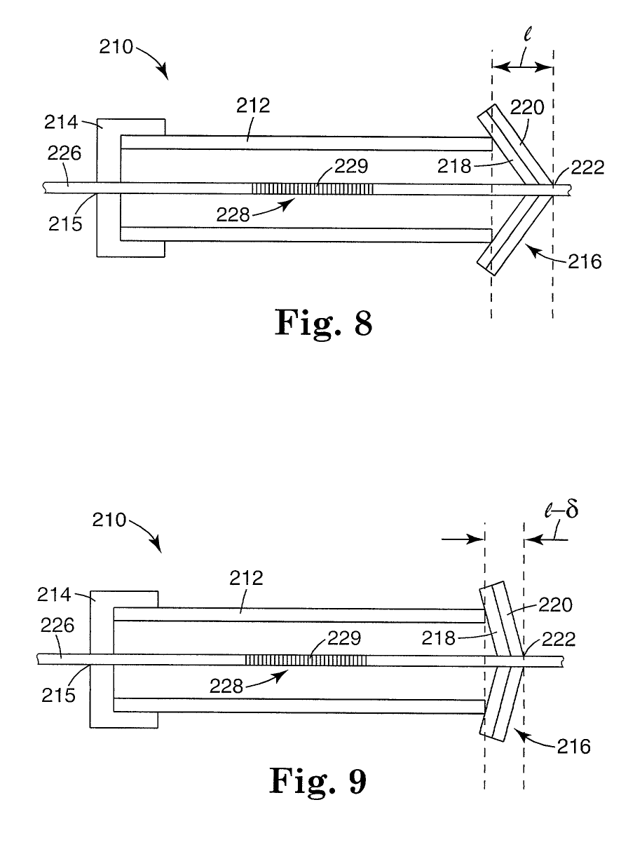

Referring to FIG. 8, another embodiment of the invention is a temperature compensating grating package 210. The package 210 includes an enclosure 212 with a first end capped by an optical fiber mounting member 214. The member 214 may be used to mount at an aperture 215 a first end of an optical fiber 226 using any conventional method such as adhesives, solder and the like. The opposite end of the enclosure 212 includes a temperature-compensating washer 216. The washer 216 is made of a first layer 218 of a material with a positive coefficient of thermal expansion. At nominal temperatures the first layer 218 has a concave shape, and is attached to a second layer 220. The second layer 220 of the washer 216 is made of a material with a coefficient of thermal expansion lower than the coefficient of thermal expansion of the first member 218. The washer 216 includes an aperture 222 that may be used to mount a second end of the optical fiber 226 at a distance ι from the second end of the enclosure 212. The optical fiber 226 includes a region 228 inside the enclosure 212 that includes a diffraction grating 229.

Referring to FIG. 9, as the temperature increases, the differences between the coefficients of thermal expansion of the adjacent layers 218, 220 cause the temperature-compensating washer 216 to flatten and become less concave. The distance from the fiber mounting point to the enclosure is reduced by a distance −δ, and the washer 216 applies an axial strain to the optical fiber 226 and the grating 229. As temperature decreases (not shown in FIG. 9), the differences between the coefficients of thermal expansion of the adjacent layers 218, 220 cause the washer 216 to return to its more concave shape. The distance from the fiber mounting point to the enclosure is increased by a distance +67 , and an axial strain is applied to the optical fiber 226. Proper selection of materials for the layers 218, 220 in the washer 216 cause the grating 229 to experience a coefficient of thermal expansion of about −9×10⁻6.

The invention will now be described with reference to the following non-limiting examples.

### EXAMPLES

### Comparative Example 1

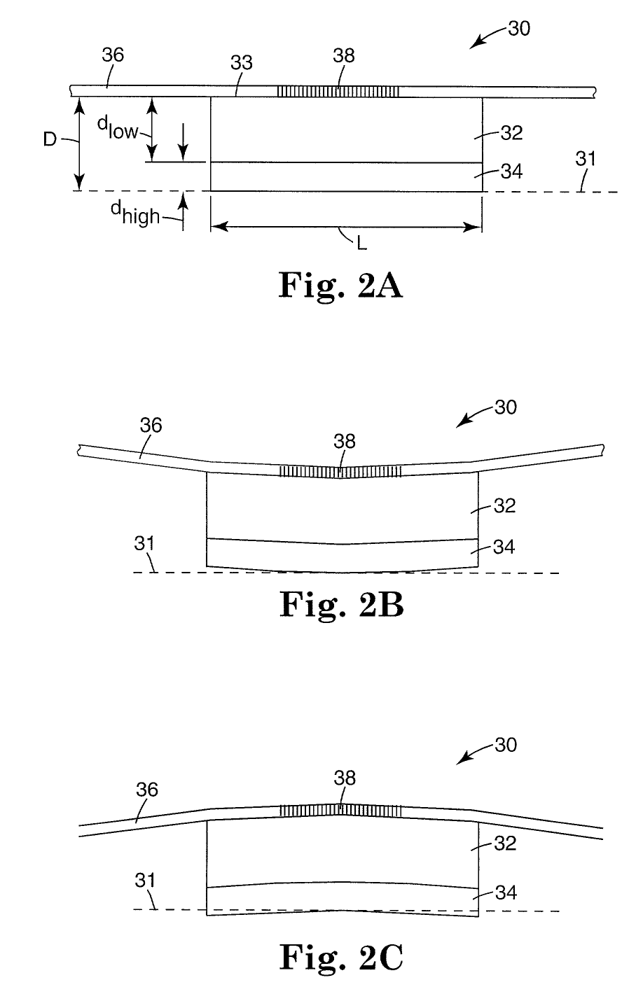

A two-layer bimetallic temperature compensating apparatus without an elevated optical fiber mount (See FIG. 2A) was prepared. The composition of the members was selected as set forth in ASTM-TM2 to provide the maximum deflection for a given temperature change. The first member, which had the largest coefficient of thermal expansion, was composed of 10% by weight Ni, 72% by weight Mn, and 18% by weight Cu. The second member, which had a smaller coefficient of thermal expansion than the first member, was composed of 64% by weight Fe and 36% by weight Ni. A region of an optical fiber containing a diffraction grating was continuously bonded to a surface of the second member.

In a series of finite element analyses, the bimetallic apparatus was exposed to a 100° C. temperature increase. The deflection of the apparatus was analyzed to establish its effective coefficient of thermal expansion (CTE) at the location of the Bragg grating, which was forced to follow the surface of the bimetallic element (See FIG. 2B). The element had a consistent initial length (L) of 1 inch (2.5 cm). Three elements having total heights (D) were analyzed: 0.050 inches (1.3 mm), 0.075 inches (1.9 mm), and 0.100 inches (2.5 mm). The height of the first member (d_{high}) was=0.53 D, and the height of the second member (d_{low}) was=0.47 D.

The results are shown in Table 1 below:

TABLE 1

| D | Effective CTE |
|---|---|
| 0.050 | −1.95 × 10⁻⁶ |
| 0.075 | −2.33 × 10⁻⁶ |
| 0.100 | −2.44 × 10⁻⁶ |

Although all of the CTE values in Table 1 are negative, none approach the desired value of about −9=10⁻⁶.

### Comparative Example 2

The bimetallic temperature compensating apparatus used in Comparative Example 1 was again subjected to a finite element analyses in which the apparatus was exposed to a 100° C. temperature increase. The deflection of the apparatus was analyzed to establish its effective CTE at the location of the Bragg grating. The optical fiber was not continuously bonded as in Comparative Example 1, but was bonded only at the opposed ends of the apparatus. In this arrangement the optical fiber was pre-tensioned and allowed to span a gap between the ends of the apparatus. The Bragg grating was located in the gap. The element had a consistent initial length (L) of 1 inch (2.5 cm). Three total element heights (D) were analyzed: 0.050 inches (1.3 mm), 0.075 inches (1.9 mm), and 0.100 inches (2.5 mm). The results are shown in Table 2 below:

TABLE 2

| D | Effective CTE |
|---|---|
| 0.050 | −2.73 × 10⁻⁶ |
| 0.075 | −2.67 × 10⁻⁶ |
| 0.100 | −2.63 × 10⁻⁶ |

Although all of the CTE values of Table 2 are negative and better than those found in Comparative Example 1, none approach the desired value of about −9×10⁻⁶.

### Example 1

Example 1 is a finite element analysis of a temperature compensation apparatus with a bimetallic element similar to that analyzed in Comparative Example 1. However, the apparatus in this example included an elevated optical fiber mount as shown in FIGS. 3-4. As in Comparative Example 2, a region of the optical fiber including a Bragg grating was positioned between the towers.

The effective CTE of the optical fiber was calculated at various tower heights, and the relationship between tower height and CTE, referred to herein as the “Tower Factor”, was calculated to be −3.83×10⁻⁷ (L/L/C)/mil. That is to say, each additional thousandth of an inch (0.025 mm) of tower height changes the effective CTE by −3.83×10⁻⁷ for this particular element geometry.

Using the Tower Factor, for a bimetallic element composed of the materials described in ASTM-TM2 with L=1 inch (2.5 cm) and D=0.050 inches (1.3 mm), finite element analysis indicated that towers of height D_{M}=0.0175 inches (0.45 mm) yielded an effective CTE for the optical fiber of approximately −9.29×10⁻⁶. Thus, to obtain an appropriate effective optical fiber CTE, the optical fiber may be pre-tensioned across the towers. The bimetallic element may then be allowed to flex to vary that tension and maintain consistent grating output wavelength with temperature.

A number of embodiments of the invention have been described. Nevertheless, it will be understood that various modifications may be made without departing from the spirit and scope of the invention. Accordingly, other embodiments are within the scope of the following claims.

What is claimed is:

1. An apparatus for temperature compensation of a region of an optical fiber, wherein the apparatus comprises
(a) a first member having a positive coefficient of thermal expansion, wherein at least a portion of the first member lies in a first plane;
(b) a second member on the first member, wherein the second member has a coefficient of thermal expansion lower than the coefficient of thermal expansion of the first member, and
(c) a mount for the optical fiber, wherein the mount is substantially normal to the first plane and extends a predetermined distance from the first plane.

2. The apparatus of claim 1, wherein the mount comprises a first tower and a second tower.

3. The apparatus of claim 2, wherein the first and second towers comprise a mounting surface for the optical fiber, wherein the mounting surfaces of the first and second towers are substantially planar.

4. The apparatus of claim 3, wherein the mounting surfaces of the first and second towers are substantially the same distance from the first plane.

5. The apparatus of claim 3, wherein the mounting surface of at least one of the first and second towers comprises a latch to retain the optical fiber.

6. The apparatus of claim 3, wherein the mounting surface of at least one of the first and second towers is metallized.

7. The apparatus of claim 3, wherein at least one of the first and second towers comprises a notch to retain the optical fiber.

8. The apparatus of claim 7, wherein the notch is elongated and extends longitudinally along the mounting tower and in a direction substantially normal to the first plane.

9. The apparatus of claim 3, wherein the coefficient of thermal expansion of the first member, the coefficient of thermal expansion of the second member, and the predetermined distance of the mounting surfaces above the first plane are selected to apply a compressive axial strain to the region with increasing temperature and a tensile axial strain to the region with decreasing temperature.

10. The apparatus of claim 2, wherein the first member comprises a first metal and the second member comprises a second metal different from the first metal.

11. The apparatus of claim 10, wherein at least one of the towers comprises the second metal.

12. A method for temperature compensating a region of an optical fiber with a diffraction grating, comprising:
(a) providing a temperature compensation apparatus comprising
(1) a first member having a positive coefficient of thermal expansion, wherein at least a portion of the first member lies in a first plane;
(2) a second member on the first member, wherein the second member has a coefficient of thermal expansion lower than the coefficient of thermal expansion of the first member; and
(3) a mount for the optical fiber, wherein the mount comprises a first tower and a second tower, and wherein the towers are substantially normal to the first plane and extend a predetermined distance from the first plane; and
(b) attaching the optical fiber to the first and second towers such that the region lies therebetween.

13. The method of claim 12, wherein in step (b) the optical fiber is attached with an adhesive to at least one of the first and second towers.

14. The method of claim 12, wherein step (b) comprises metallizing the optical fiber and soldering the optical fiber to at least one of the first and second towers.

15. The method of claim 12, wherein at least one of the first and second towers comprises a latch, and the optical fiber is attached to the tower with the latch.

16. The method of claim12, wherein step (b) is performed with the optical fiber under tension.

17. A temperature compensating package for a fiber optic Bragg grating, comprising an enclosure with a first end and a second end, an optical fiber mount on a first end of the enclosure, and a temperature compensating washer on the second end of the enclosure, wherein the washer comprises a disk with an aperture, wherein the disk comprises a first layer adjacent the second end of the enclosure and a second layer on the first layer, wherein the first layer has a positive coefficient of thermal expansion and the second layer with a coefficient of thermal expansion lower than the coefficient of thermal expansion of the first layer.

18. A temperature compensating optical device, comprising:
(a) a first member having a positive coefficient of thermal expansion, wherein at least a portion of the first member lies in a first plane;
(b) a second member on the first member, wherein the second member has a coefficient of thermal expansion lower than the coefficient of thermal expansion of the first member;
(c) a mount for the optical fiber, wherein the mount comprises a first tower and a second tower, wherein the first and second towers are substantially normal to the first plane and extend a predetermined distance from the first plane; and
(d) an optical fiber attached to the first and second towers, wherein a region between the first and second towers comprises a diffraction grating.

19. A temperature compensating optical device, comprising:
(a) an enclosure with a first end and a second end,
(b) an optical fiber mount on a first end of the enclosure,
(c) a temperature compensating washer on the second end of the disclosure, wherein the washer comprises a disk with an aperture, wherein the disk comprises a first layer adjacent the second end of the enclosure and a second layer on the first layer, wherein the first layer has a positive coefficient of thermal expansion and the second layer with a coefficient of thermal expansion lower than the coefficient of thermal expansion of the first layer; and
(d) an optical fiber attached to the fiber mount and the washer, wherein a region of the optical fiber is within the enclosure, and wherein the region comprises a diffraction grating.
